(19) United States
(12) Patent Application Publication
(10) Pub. No.: US 2013/0019187 A1
(43) Pub. Date: Jan. 17, 2013

(54) VISUALIZING EMOTIONS AND MOOD IN A COLLABORATIVE SOCIAL NETWORKING ENVIRONMENT

(71) Applicants: JOHN R. HIND, RALEIGH, NC (US); ABDOLREZA SALAHSHOUR, RALEIGH, NC (US); TINTIN S. SOEMARGONO, CARY, NC (US); STEFANUS WIGUNA, CARY, NC (US)

(72) Inventors: JOHN R. HIND, RALEIGH, NC (US); ABDOLREZA SALAHSHOUR, RALEIGH, NC (US); TINTIN S. SOEMARGONO, CARY, NC (US); STEFANUS WIGUNA, CARY, NC (US)

(73) Assignee: INTERNATIONAL BUSINESS MACHINES CORPORATION, ARMONK, NY (US)

(21) Appl. No.: 13/184,312

(22) Filed: Jul. 15, 2011

(51) Int. Cl. G06F 3/01; G06F 15/16

(52) U.S. Cl. 715/753

(57) ABSTRACT

Techniques are described for conveying a collective emotional state of a plurality of participants to a communication. Embodiments receive emotional state data for each of the participants to the communication. The emotional state data for each of the participants is collected by monitoring at least one or more applications the respective participant is interacting with. An emotional state of the participants to the communication is then determined, based on the received emotional state data and a determined topic of the communication. Embodiments provide an indication of the determined emotional state of the participants.

### BACKGROUND

Embodiments presented in this disclosure generally relate to teleconferencing and, more particularly, to providing feedback to a presenter describing the mood of participants to a teleconference.

Due to recent trends toward telecommuting, mobile offices and the globalization of businesses, more and more employees are being geographically separated from each other. As a result, more and more teleconferences are occurring at the work place. Generally, a teleconference involves non-face-to-face interactions among participants. Particularly, a teleconference is a conference in which participants communicate with each other using telecommunication devices such as telephones or computer systems. Collaboration software, such as IBM Lotus Web conferencing, enables the participants to view and share applications, annotate documents, chat with other participants, or conduct an interactive white board session using their computer systems.

As with any conversation or meeting, sometimes a participant might be intellectually stimulated by what is being communicated and other times the participant might be totally disinterested. Face-to-face communications provide a variety of visual cues that ordinarily help in ascertaining whether a communication is being understood or even being heard. For example, non-verbal behaviors such as visual attention and head nods during a conversation are often indicative of understanding. Certain postures, facial expressions and eye gazes may provide social cues as to a person's emotional state. However, even with face-to-face communications, it may be difficult for a presenter to accurately gauge another person's mood. For instance, a person in the same room as the presenter that is using their laptop during a presentation could be using the laptop to look up information relevant to the presentation or could be using their laptop to browse websites that are unrelated to the presentation. However, without inspecting the laptop's display, the presenter may have no way of knowing whether the participant is interested in the presentation or not. Furthermore, non-face-to-face communications may be completely devoid of such cues.

### SUMMARY

Embodiments of the invention provide a method, computer program product and system for indicating a collective emotional state of a plurality of participants to a communication. The method, computer program product and system include receiving emotional state data for each of the plurality of participants to the communication. Here, the emotional state for each of the participants is collected by monitoring one or more applications the participant is interacting with. The method, computer program product and system also include determining the collective emotional state of the plurality of participants to the communication. Such a determination is based on the received emotional state data and a determined topic of the communication. Additionally, the method, computer program product and system include providing an indication of the collective emotional state of the plurality of participants to the communication.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system configured to operate an emotional state component, according to one embodiment presented in this disclosure.

FIG. 2 is a block diagram illustrating a system configured to operate a monitoring component, according to one embodiment presented in this disclosure.

FIGS. 3A-3B are screenshots of user interfaces for an emotional state component, according to one embodiment presented in this disclosure.

FIG. 4 is a flow diagram illustrating a method for providing an indication of a participant's emotional state, according to one embodiment presented in this disclosure.

FIGS. 5A-5B are flow diagrams illustrating methods for providing an indication of a participant's emotional state, according to embodiments presented in this disclosure.

FIG. 6 is a block diagram illustrating a system configured to operate an emotional state component, according to one embodiment presented in this disclosure.

### DETAILED DESCRIPTION

As discussed above, a host (i.e., a presenter) may have difficulty in determining the mood of the participants to the presentation. For instance, the host may have no way of knowing if a participant using a laptop is interacting with applications that are relevant to a topic of the presentation, which could indicate the participant is interested in the presentation, or if the participant is interacting with off-topic applications, which could indicate the participant is bored with the presentation. Furthermore, it is particularly difficult for the host to ascertain the emotional state of the participants when the presentation is made via a teleconference, as the host is unable to see visual indicators from the remote participants that could indicate the participants' interest or disinterest in the presentation (e.g., eye contact, affirmative gestures such as nodding, and so on).

As such, embodiments of the present invention provide techniques for determining a collective emotional state of participants to a communication. As defined herein, a “communication” broadly refers to any real time exchange of information between multiple parties. Examples of such a communication could include a remote communication (e.g., a presentation given by way of a teleconference) or a local communication (e.g., a team meeting hosted in a conference room). As an example, the communication could include a social network chat as well, such as an IBM Sametime® chat communication. A communication may also include a mix of remote and local participants. Embodiments may determine a topic of the communication. Generally, the topic describes one or more fields (e.g., networking, cloud computing, etc.) or entities (e.g., a particular new product) that are the subject of a communication or that the communication otherwise relates to.

Additionally, embodiments receive emotional state data for each of the other participants to the communication. Such emotional state data could be collected by monitoring actions performed by or characteristics of the other participants. An emotional state for the other participants to the communication is then determined, based on the received emotional state data and the determined topic of the communication. Embodiments may also provide the host of the communication with an indication of the determined emotional state for the other participants to the communication. As another example, embodiments may provide each participant to the communication with the determined emotional of the other participants. For instance, embodiments could provide each participant to an IBM Sametime® chat communication with an indication of the emotional state of the other participants to the communication.

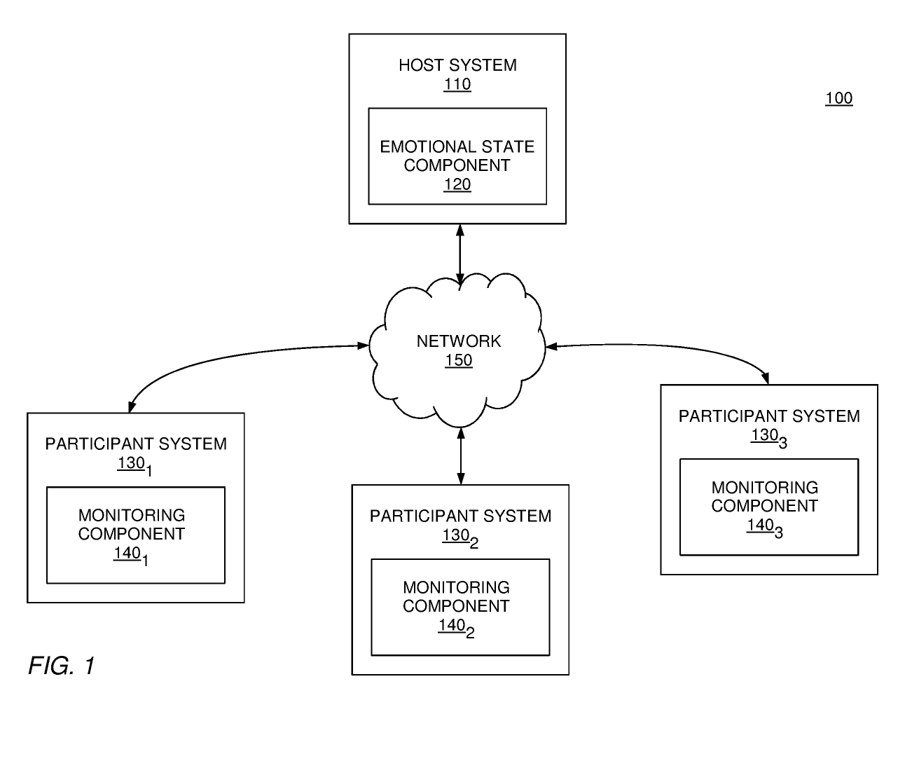

FIG. 1 is a block diagram illustrating a system configured to operate an emotional state component, according to one embodiment presented in this disclosure. As shown, the system 100 includes a host system 110 and a plurality of participant systems 130, interconnected via a network 150. Generally, the host system 110 represents any computing system associated with a host of a communication (e.g., a presentation) and the participant systems 130 represent computing systems associated with participants to the communication. Examples of such systems 110 and 130 could include desktop computer systems, laptop computers, tablet computers, mobile devices (e.g., mobile phones, mp3 players, etc.) and so on. The host system 110 includes an emotional state component 120. Additionally, each participant system includes a respective monitoring component 140.

Generally, the monitoring component 140 monitors characteristics and/or actions of the participant associated with the respective participant system 130. In particular embodiments, the monitoring component 140 monitors the participant using common equipment found in most computing devices (e.g., keyboards, microphones, etc.) and without the need for any special hardware. For instance, the monitoring component 140₁ could monitor which applications the participant is using on the participant system 130₁ during the communication. Generally, the monitoring component 140 may monitor any actions that may be used to determine an emotional state of the participant. As referred to herein, “emotional state data” refers to any data collected by the monitoring component 140.

For instance, the monitoring component 140₁ could monitor which applications the user is interacting with and transmit this emotional state data to the emotional state component 120. The emotional state component 120 could then use this emotional state data in determining the emotional state of the participant. For instance, if the emotional state component 120 determines that the user is interacting with an application that is unrelated to the topic of the presentation, the emotional state component 120 may determine that the participant is distracted from or otherwise uninterested in the presentation. If, instead, the emotional state component 120 determines the participant is interacting with applications related to the topic of the presentation, the emotional state component 120 could determine that the participant is interested in the presentation. In one embodiment, the emotional state component 120 is configured to further consider a frequency and duration of the participant's interactions with the various applications. For example, if the user momentarily checks a stock ticker during the presentation, the emotional state component 120 could determine that this interaction does not indicate the user is disinterested in the presentation, even though the stock ticker is completely unrelated to the topic of the presentation.

As another example, the monitoring component 140 could monitor the participant's typing speed during the presentation. In certain embodiments, the monitoring component 140 is configured to monitor keyboard typing patterns of the participant. For example, the monitoring component 140 could monitor the frequency with which the participant is using the backspace key, as a higher frequency of backspaces could indicate the participant is being carelessness with his typing, which may indicate that the participant is frustrated or annoyed by the communication. The monitoring component 140 could then transmit the collected typing data to the emotional state component 120 on the host system 110 for processing.

Continuing the example, the emotional state component 120 could compare the participant's current typing speed to historical typing speeds of the participant for use in determining the participant's emotional state. If the emotional state component 120 determines the participant is typing faster than normal, this could indicate, for instance, that the user is interested in the presentation and is actively taking notes on the presentation (e.g., if the participant is interacting with a word processing application) or that the user is distracted from the presentation by other pressing matters (e.g., if the participant is interacting with unrelated applications). Likewise, if the emotional state component 120 determines that the participant is using a substantial amount of backspaces, the emotional state component 120 could determine that the participant is angry or unnerved during the presentation. The emotional state component 120 may also compare the participant's current frequency of backspaces to historical frequency data for the participant to determine whether the current frequency is a relatively high or low frequency for the participant. Advantageously, by maintaining and using such historical data for the participant, embodiments may effectively learn the behavior of the participant over a period of time and how certain behaviors relate to the participant's mood or emotions.

In one embodiment, each of the participant systems is configured with a respective emotional state component 120 that maintains historical emotional state data for the corresponding participant and is configured to determine the participant's emotional state during the communication. In a particular embodiment, the emotional state component 120 on each of the participant systems 130 maintains the historical data only for the duration of the communication. Advantageously, doing so minimizes any privacy concerns by the participant, as the historical data may then be purged at the end of the communication. In such an embodiment, the emotional state components 120 on the participant systems 130 may determine the emotional state of each respective participant and transmit this information to the emotional state component 120 on the host system 110. Upon collecting the emotional states of all the participants, the emotional state component 120 on the host system 110 could display a visual indication of the collective emotional state of all the participants to the communication.

Oftentimes, a single metric such as typing speed is insufficient for the emotional state component 120 to determine the participant's emotional state during the presentation. As such, the monitoring component 140₁ may monitor various types of actions and transmit data collected from such monitoring to the emotional state component 120 for use in determining the emotional state of the participant. In such an embodiment, the emotional state component 120 could calculate an emotional state score for each of the types of emotional state data, the score reflecting a potential mood of the participant. The emotional state component 120 could then apply weights to each of the calculated scores to determine the emotional state of the participant. For example, the emotional state component 120 could be configured to consider application interaction data to be twice as informative as typing speed data for the user by applying a larger weight to the score produced from the application interaction data. Of course, these examples are without limitation and are provided for illustrative purposes only. Moreover, one of ordinary skill in the art will recognize that any number of other factors may be considered and different emotional states could be determined, consistent with the present disclosure.

Upon determining the emotional state of the participant, the emotional state component 120 provides an indication of the participant's emotional state to the host of the presentation. For instance, the emotional state component 120 could display a visual indication of the participant's emotional state to the host using a display device connected to the host system 110. In one embodiment, the emotional state component 120 is configured to display a visual indication of each participant's emotional state to the host. Such an embodiment may be advantageous when there are a relatively small number of participants to the presentation. In another embodiment, the emotional state component 120 is configured to generate a visual indication representing the average emotional state for all of the participants to the presentation. An indication of the average emotional state for all the participants may be advantageous when, for instance, a substantial number of participants are involved in the presentation, as it conveys the collective emotional state of the participants to the host without overloading the host with information. That is, the host may easily glance at the single visual indicator to determine the participants' collective emotional state during the presentation, which advantageously prevents the host from becoming distracted by attempting to monitor an overload of emotional state data during the presentation.

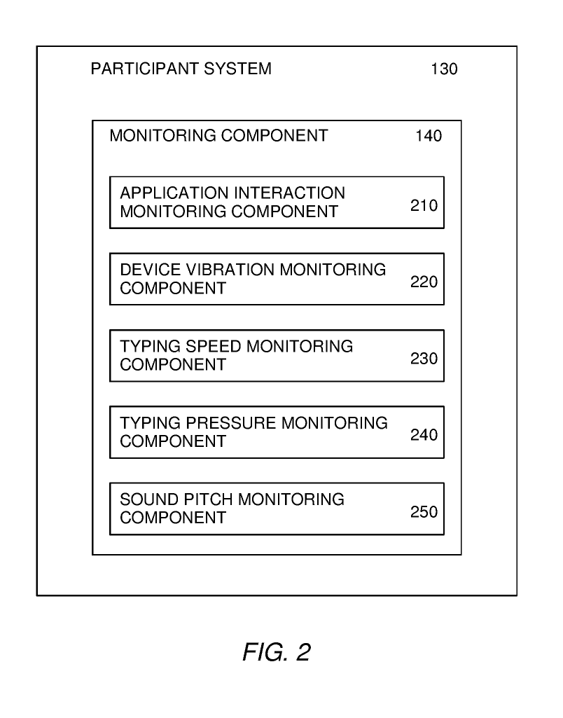

As discussed above, the monitoring component 140 may monitor a variety of metrics and actions for a participant. An example of this is shown in FIG. 2, which is a block diagram illustrating a system configured to operate a monitoring component, according to one embodiment presented in this disclosure. As shown, the participant system 130 includes a monitoring component 140, which in turn contains an application interacting monitoring component 210, a device vibration monitoring component 220, a typing speed monitoring component 230, a typing pressure monitoring component 240 and a sound pitch monitoring component 250.

The participant system 130 may further contain storage media (not shown) for storing historical participant data collected by the monitoring component 140. Examples of such storage media could include hard-disk drives, flash memory devices, optical media and the like. In one embodiment, the monitoring component 140 is configured to maintain historical participant data on the participant system 130 only for a fixed duration (e.g., the duration of the current communication, for a fixed period of time after the current communication, and so on). Doing so may reduce privacy concerns for users of the participant systems, as the data collected by monitoring the actions of the users in such an embodiment is purged at the conclusion of the communication and thus cannot be used for other purposes.

Additionally, by maintaining historical participant data for the participant, the emotional state component 120 may account for participant-specific behaviors of the participants. For instance, a particular user may consistently apply a substantial amount of pressure to the keyboard while typing. As such, when the emotional state component 120 determines that the particular user is again applying a substantial amount of pressure while typing, the emotional state component 120 may determine that this is merely normal behavior for the participant. As another example, a second user suffering from Parkinson's disease may often shake his hands or legs while using the participant system and this behavior could be reflected in the historical data maintained for the second user. The emotional state component 120 could then factor this behavior in when evaluating vibration data to determine the emotional state of the second user. Of course, the above examples and the depicted example of a monitoring component are without limitation and are provided for illustrative purposes. More generally, any monitoring component capable of monitoring user characteristics and/or actions to collect emotional state data may be used in accordance with embodiments of the invention.

Returning to the depicted example, the application interaction monitoring component 210 generally monitors which applications the participant is interacting with on the participant system 130. The information collected from such monitoring could then be transmitted to an emotional state component 120 for use in determining the emotional state or mood of the participant. For instance, if the emotional state component 120 determines the participant is interacting with applications that are not related to the topic of the teleconference, the emotional state component 120 could further determine that the participant is disinterested in the teleconference. The application interaction monitoring component 210 could also monitor the amount of time or frequency with which the user is interacting with each application. For instance, if the emotional state component 120 determines that a participant occasionally checks his email during the presentation, the emotional state component 120 could further determine that this factor alone does not indicate the user is disinterested in the presentation. However, if the emotional state component 120 determines that a second participant is constantly reading and writing emails during the presentation, the emotional state component 120 could determine that the second participant is disinterested with the presentation.

Additionally, the typing speed monitoring component 230 generally measures a rate at which the user is typing on a keyboard connected to the participant system (e.g., in words per minutes). The monitoring component 140 could then transmit this information to the emotional state component 120 for use in determining the participant's emotional state. Furthermore, the emotional state component 120 could compare the rate at which the participant is currently typing to historical emotional state data previously collected from the participant to determine the relative speed of the participant's typing. That is, a speed of 50 words per minute (“wpm”) may be considered slow for a participant that types 80 wpm on average, but the same speed of 50 wpm may be considered fast for a second participant that types 30 wm on average. Upon receiving the emotional state data from the monitoring component 140, if the emotional state component 120 determines that the participant is not only using an application that is unrelated to the topic of the communication but is also typing at a relatively fast rate, the emotional state component 120 could determine that the user is disinterested in the material being presented. Alternatively, if the emotional state component 120 determines that the participant is using an application that is unrelated to the topic of the communication but is typing at a slower rate, the emotional state component 120 may determine that the user is only somewhat disinterested in the communication.

The device vibration monitoring component 220 is configured to monitor vibrations felt by the participant system 130. For instance, in one embodiment the device vibration monitoring component 220 is an accelerometer. The emotional state component 120 could use the vibration data collected from the device vibration monitoring component 220 to detect, for instance, detect when a user has slammed his hands on the desk, as this could indicate the user is annoyed by the presentation. As another example, the emotional state component 120 could use the vibration data to determine when the participant is moving with the participant system 130 (e.g., where the participant system 130 is a laptop). That is, if the participant is moving his laptop from one conference room to another, that may indicate that the participant is not currently paying attention or interested in the presentation.

As yet another example, embodiments may maintain historical information for a particular user which may be used to evaluated the monitored vibration measurements. For instance, the device vibration monitoring component 220 may store historical data indicating that a first participant does not normally shake his hands or legs during presentations. If the device vibration monitoring component 220 then detects the first participant is shaking his legs during a presentation, the emotional state component 120 could interpret this data as indicating that the first participant is frustrated or annoyed. As another example, the device vibration monitoring component 220 could store historical data indicating that a second participant with Parkinson's disease frequently shakes his hands or legs involuntarily. If the device vibration monitoring component 220 then detects vibrations from that the second participant during a presentation, the emotional state component 120 could interpret this data as normal for the second participant based on the historical data. Advantageously, doing so enables embodiments of the invention to account for behavioral differences between the participants to the conversation.

The monitoring component 140 in the depicted example also contains a typing pressure monitoring component 240. The typing pressure monitoring component 240 generally monitors the force exerted on the keyboard by the user of the participant system 130. In one embodiment, the typing pressure monitoring component 240 uses a microphone connected to the participant system 130 to determine how loudly the participant is typing on the keyboard. Advantageously, such an embodiment allows the typing pressure monitoring component 240 to operate without using any special hardware. In another embodiment, the participant system 130 is connected to a particular keyboard configured with pressure sensors which are in turn monitored by the typing pressure monitoring component 240. The emotional state component 120 could use the emotional state data collected from the typing pressure monitoring component 240 to, for instance, determine when a user is annoyed or frantic during the presentation. That is, if a participant suddenly begins typing with a substantial amount of pressure on the keyboard (e.g., when the sound of the participant's typing grows louder), the emotional state component 120 may determine that the emotional state of the participant is annoyed or frustrated by content from the presentation.

Additionally, the sound pitch monitoring component 250 may monitor (e.g., using a microphone connected to the participant system 130) words or sounds (e.g., a sigh) uttered by the participant. The emotional state component 120 could then compare the determined pitch with historical pitch data collected for the participant for use in determining the participant's current emotional state. For instance, if the emotional state component 120 determines the participant is currently speaking more loudly and in a higher pitch than usual (i.e., based on the historical pitch data), the emotional state component 120 could determine that the participant is unsettled or annoyed by the presentation. Likewise, a lower than normal pitch could indicate that the user is calm, but could also indicate that the user is disinterested by the presentation. As yet another example, if the emotional state component 120 determines that a participant has sighed in response to the presentation, this may indicate that the participant is agitated or frustrated with the presentation. Of course, the above examples are without limitation and are merely provided for illustrative purposes only. More generally, the monitoring component 140 may be configured to monitor any actions or characteristics of a participant that may be used in determining the participant's emotional state or mood.

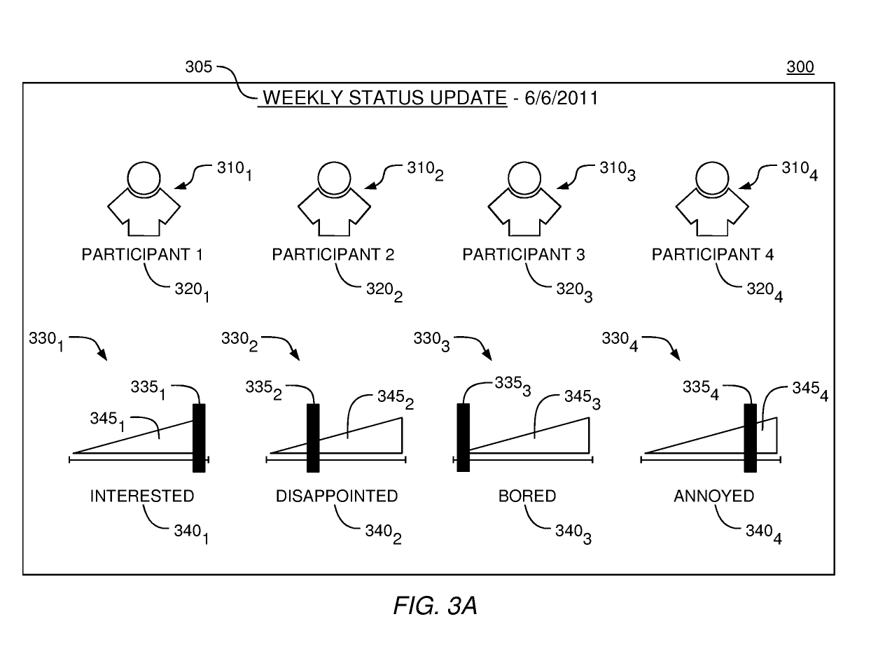

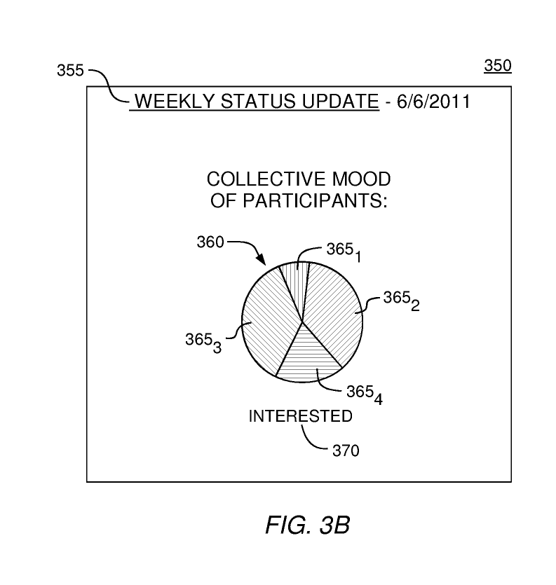

Upon receiving emotional state data from the monitoring components 140 of the participant systems 130, the emotional state component 120 may provide an indication of the participants' emotional states to the host of the presentation. Examples of such indications are shown in FIGS. 3A-3B, which are screenshots of user interfaces for an emotional state component, according to embodiments presented in this disclosure. As shown in FIG. 3A, the screenshot 300 includes a title 305 for the current communication. In the depicted example, the title 305 of the communication is “Weekly Status Update—Jun. 6, 2011.” Additionally, the screenshot 300 includes participant icons 310, participant names 320, visual emotional state indicators 330 and textual emotional state indicators 340 for the participants to the communication.

Each of the visual emotional state indicators 330 includes an indicator bar 335 and a scale 345. Generally, the indicator bar 335 may slide back and forth across the scale 345 based on the corresponding participant's current emotional state. For instance, the screenshot 300 shows that the participant with participant name 320₁ “PARTICIPANT1” has a visual emotional state indicator 330₁ describing the participant as interested in the current communication. That is, because the indicator bar 335₁ is positioned at the highest point of the scale 345₁, this indicates that the corresponding participant is highly interested in the presentation. This is further shown by the textual emotional state indicator 340₁, which describes the participant's mood as “INTERESTED.” Likewise, the participant with participant name 320₃ “PARTICIPANT3” has a visual emotional state indicator 330₃ indicating that the participant is bored with the communication, which is further shown by the textual indicator 340₃ which shows the participant's mood as “BORED.”

In a particular embodiment, the scales 345 may be colored as a two-color gradient to visually indicate the potential emotional states of the participant. For example, the shorter end of the scales 345 may be colored red and the taller end colored blue, with the areas in between being various shades of purple. In such an embodiment, the emotional state component 120 could color the participant icon 310 based on the current position of the corresponding indicator bar 335 on the scale 345. For instance, in such an example, a participant who is very interested in the presentation could have their participant icon 310 colored blue, while a participant who is disinterested in the presentation could have their participant icon 310 colored red. Doing so enables the user viewing the interface 300 to quickly discern the emotional state of a participant by looking at the current color of the participant icon 310. For instance, the host of a presentation could glance at the user interface of the emotional state component 120 and determine how the participants are reacting to the presentation. Continuing the example, if the interface indicates that most of the participants are bored with the presentation, the host could change topics or otherwise make the presentation more interesting to the participants.

In one embodiment, the emotional state component 120 provides an interface with a single visual indicator representing a collective emotional state of the participants to the communication. Such an embodiment may be advantageous when, for instance, there are a substantial number of participants to the communication. That is, in such a situation, it may be difficult for the user interface to display separate indicators for each of the participants and it may be even more difficult for the host to quickly process the information conveyed by such a substantial number of separate visual indicators. As such, the emotional state component 120 may be configured to identify a collective emotional state of all the participants to the communication and to display a single indicator representing the collective emotional state.

An example of a single visual indicator is shown in FIG. 3B, which is a screenshot of a user interfaces for an emotional state component, according to one embodiment presented in this disclosure. As shown, the screenshot 350 includes a title 355 for the current communication, a visual indicator 360 representing the collective mood of the participants to the communication, and a textual state indicator 370 describing the collective mood of the participants. Here, the title 355 of the communication is “Weekly Status Update—Jun. 6, 2011.” Additionally, in the depicted example, the emotional state component 120 has determined that the collective emotional state for all the participants to the communication is interested, as represented by the visual indicator 360 and further shown by the textual state indicator 370, which describes the participants' collective mood as “INTERESTED.”

In the depicted example, the visual indicator 360 is a pie chart representing how interested the participants are in a given presentation. Here, pie 365₁ represents the participants that are very disinterested, pie 365₂ represents the participants that are very interested, pie 365₃ represents the participants that are moderately interested and pie 365₄ represents the participants that are moderately disinterested in the presentation. Here, since the majority of participants are either very interested or moderately interested in the presentation (i.e., as shown by the pies 365₂ and 365₃), the textual state indicator 370 indicates that the collective emotional state is “INETERESTED” in the presentation. Furthermore, in an embodiment where the emotional state component 120 represents the emotional state of the participants using a gradient coloring scheme, the pies 365 may each be colored based on their corresponding color. For instance, in the above example where very disinterested participants were represented in red and very interested participants were represented in blue, the pie 365₁ could be colored red, the pie 365₄ colored light purple, the pie 365₃ colored dark purple and the pie 365₂ colored blue.

Advantageously, doing so provides a single point of reference for the host to monitor during the communication to determine information about the collective emotional state of the participants. Furthermore, by color coding the pies 365 within the visual indicator 360, embodiments may help to ensure that users can quickly and easily determine the emotional state of the participants to the communication. Additionally, in one embodiment, the emotional state component 120 is configured to display a visual indicator of the collective emotional state of the participants in addition to individual emotional state indicators for each of the participants. Advantageously, such an embodiment provides the presenter with information on the mood of each participant, while still providing the presenter a single point of reference for identifying the collective mood of the participants.

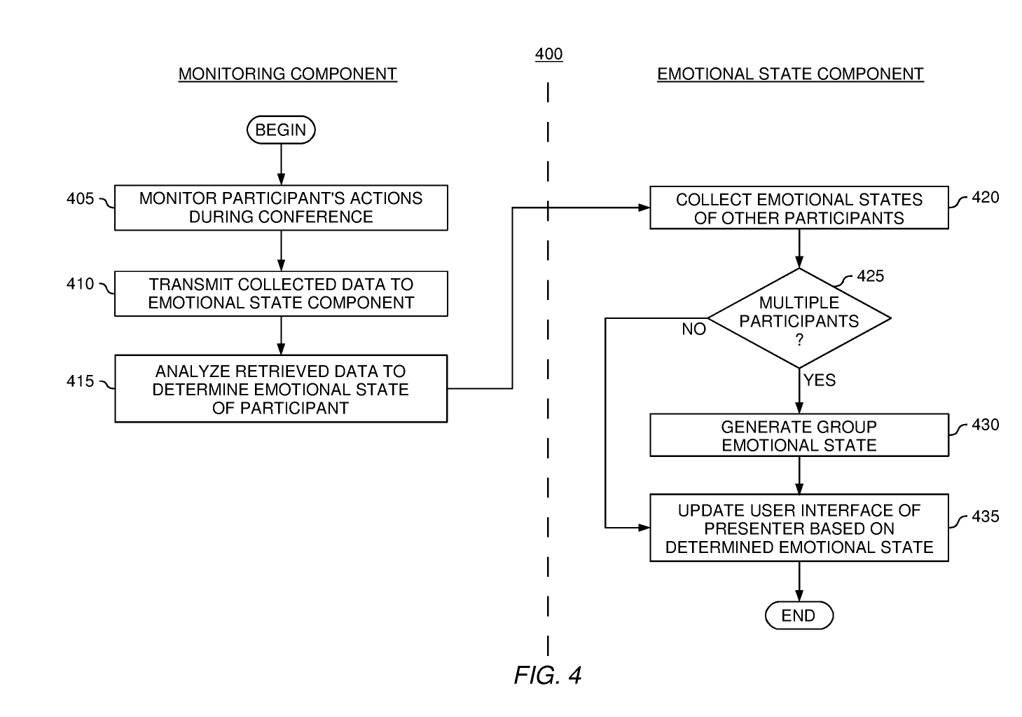

FIG. 4 is a flow diagram illustrating a method for providing an indication of a participant's emotional state, according to one embodiment presented in this disclosure. As shown, the method 400 begins at step 405, where a monitoring component 140 monitors a participant's actions during a teleconference to collect emotional state data for the participant. As discussed above, the monitoring component 140 may be configured to monitor a variety of different characteristics and actions of the participant, including what applications the participant is interacting with, how fast the participant is typing, how much pressure the participant is exerting on the keyboard, and so on. The monitoring component 140 then transfers the collected emotional state data to the emotional state component 120 running on the participant system (step 410).

The emotional state component 120 on the participant machine analyzes the received emotional state data and determines a current emotional state of the participant (step 415). For instance, the emotional state component 120 could determine a topic for the conference and use the determined topic to interpret the received emotional state data. As an example, the emotional state component 120 could determine that the teleconference relates to the topic of computer networking. If the emotional state component 120 then receives data from the monitoring component 140 indicating that the participant is browsing networking-related web sites, the emotional state component 120 could determine that the received data indicates the participant is interested in the teleconference. On the other hand, if the received data indicates that the participant is browsing financial web sites during the teleconference, the emotional state component 120 could determine that the participant is disinterested in or bored with the teleconference, as the financial web sites have little to do with the topic of the teleconference (i.e., computer networking).

In one embodiment, the emotional state component 120 compares the received data with historical emotional state data for the participant in order to interpret the received data. Such historical emotional state data may be maintained in data storage on the participant system. Additionally, in one embodiment, the emotional state component 120 is configured to purge the historical emotional state data at the conclusion of the communication. Doing so may alleviate potential privacy concerns of the participants, as the data collected by monitoring the actions of the participants is not maintained past the conclusion of the current communication and thus cannot be used for any other purposes. Additionally, by maintaining historical emotional state data for the participant, the emotional state component 120 may account for participant-specific behaviors in determining the emotional state of the participant. As an example, a given participant may frequently exert a substantial amount of pressure when typing, which may be reflected in the historical emotional state data. As such, when the emotional state component 120 receives data from the monitoring component 140 that indicates the given participant is again using a substantial amount of pressure when typing, the emotional state component 120 may consider this behavior normal for the given participant. However, if the emotional state component 120 receives data indicating that a second participant is exerting a substantial amount of pressure while typing and the second participant typically only uses a small amount of pressure while typing (e.g., as reflected by the historical emotional state data), the emotional state component 120 could interpret the received data as indicating the second participant is in an annoyed or frantic emotional state.

The determined emotional state is then transmitted to a second emotional state component running on a presenter system. As an example, the determined emotional state could be transmitted using IP over HTTP communications using a network connecting the participant system and the presenter system. More generally, any method of transmitting the determined emotional state to the second emotional state component running on the presenter system may be used in accordance with embodiments of the present invention. The emotional state component 120 on the presenter system then collects emotional states of other participants (step 420). For instance, each participant to the communication may have a corresponding participant system equipped with an emotional state component 120, configured to monitor the participant's actions and determine the participant's emotional state during the conference. These participant emotional state components 120 could then transmit the determined emotional state of their corresponding participant to the emotional state component 120 on the presenter system.

Once the emotional states of the other participants are collected, the emotional state component 120 on the presenter system determines whether there are multiple participants to the communication (step 425). Upon determining there are multiple participants, the emotional state component 120 on the presenter system generates a collective emotional state based on the collected emotional states for the participants (step 430). For example, if the majority of the collected emotional states indicate that their corresponding participants are interested in the conference, the emotional state component 120 on the presenter system could determine that the group emotional state is “interested.”

Once the group emotional state is determined, or once the emotional state component 120 on the presenter system determines that there is only a single participant to the conference, the emotional state component 120 updates the user interface of the presenter based on the determined emotional states (step 435). In particular embodiments, the emotional state component 120 may display a visual indicator describing the collective emotional state of all the participants to the conference. For instance, the emotional state component 120 could generate a pie chart to indicate the collective emotional state, similar to the visual indicator shown in FIG. 3B. In one embodiment, the emotional state component 120 could update the interface to show a separate visual indicator of the emotional state of each participant to the conference, as shown in FIG. 3A and discussed above. Upon updating the user interface to reflect the participant's emotional state, the method 400 ends.

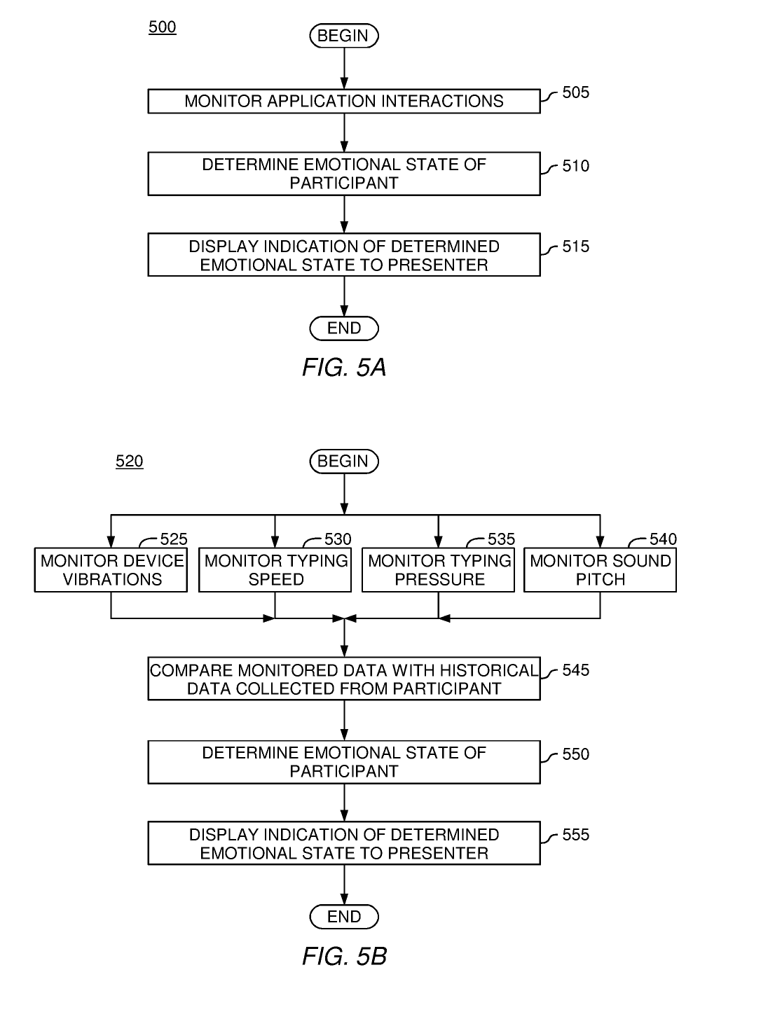

FIGS. 5A-B are flow diagrams illustrating methods for providing an indication of a participant's emotional state, according to embodiments presented in this disclosure. As shown in FIG. 5A, the method 500 begins at step 505, where a monitoring component 140 monitors application interactions on a participant system for a participant to a presentation. For instance, the monitoring component 140 could monitor which applications the participant is interacting with and how frequently the participant is interacting with each application.

The emotional state component 120 then determines the current emotional state of the participant based on the received emotional state data (step 510). For example, the emotional state component 120 could identify a topic of the communication and then determine whether the applications with which the participant is interacting are related to the identified topic. For instance, if the emotional state component 120 determines the presentation is related to the topic of computer networking, then the emotional state component 120 could further determine that a user browsing computer networking articles on the Internet is interested in the presentation. As another example, the emotional state component 120 could determine that a user checking the scores for recent sporting events is disinterested in the presentation. Once the participant's emotional state is determined, the emotional state component 120 displays an indication of the determined emotional state to the presenter of the presentation (step 515), and the method 500 ends. Advantageously, by providing the participant's current emotional state to the presenter of the presentation, embodiments enable the presenter to dynamically adjust his presentation based on the audience's mood. That is, if the emotional state component 120 determines that the majority of the participants to the presentation are bored or disinterested in the presentation, the presenter could change topics or attempt to otherwise make the presentation more interesting, so as to better captivate his audience.

In one embodiment, a first emotional state component 120 on the participant system determines the current emotional state of the participant (at step 510) and then transmits the determined current emotional state to a second emotional state component running on a presenter system (e.g., using a network). One advantage to such an embodiment is that the emotional state data collected by monitoring the actions of the participant is maintained locally on the participant system. This may help to alleviate potential privacy concerns of the participant, as the emotional state data is not transmitted and/or stored outside of the participant system. Additionally, in one embodiment, the emotional state component 120 on the participant system is configured to purge the emotional state data collected during a particular communication after a predetermined period of time (e.g., at the conclusion of each communication). Doing so may further alleviate privacy concerns of the participants, as the emotional state data collected by monitoring the actions of the participants is maintained only for a fixed amount of time.

FIG. 5B is a flow diagram illustrating a method for providing an indication of a participant's emotional state, according to one embodiment presented in this disclosure. As shown, the method 520 begins with the monitoring component 140 collecting emotional state data from one or more of the monitored actions or characteristics of a participant. For instance, the monitoring component 140 monitors device vibrations on the participant system (step 525), the speed at which the participant is typing on the participant system (step 530), and how much pressure the participant exerts while typing (step 535). Of note, in particular embodiments, the monitoring shown in steps 525, 530, 535 and 540 may be performed in addition to the monitoring of application interactions shown in step 505 of FIG. 5A and discussed above. In such embodiments, the data collected from the monitoring in steps 525, 530, 535 and 540 may be used to further refine the current emotional state of the participant (e.g., from step 510) determined based on the application interactions of the participant. Advantageously, doing so may allow the emotional state component 120 to more accurately determine the emotional state of the participant.

As discussed above, in particular embodiments, the monitoring component 140 determines the typing pressure for the participant by monitoring how loudly the participant is typing (e.g., using a microphone). Additionally, in the depicted example, the monitoring component 140 further monitors the pitch of any words spoken by the participant during the presentation (step 540). The monitoring component 140 may transmit data collected from such monitoring to the emotional state component 120 for analysis.

Upon receiving the emotional state data, the emotional state component 120 compares the emotional state data with historical data collected from the participant (step 545). That is, by comparing the emotional state data with historical data, the emotional state component 120 may determine the relative value of the collected data and use this information to properly interpret the data. For example, without any context, the emotional state component 120 may be unable to determine whether a particular user's current typing speed of 50 wpm is fast or slow for the particular user. However, by comparing the user's current typing speed with historical typing speed data for the user, the emotional state component 120 may accurately interpret the emotional state data. Of note, the emotional state data collected from the monitoring in steps 525, 530, 535 and 540 may then be stored on the participant system as additional historical data, so that the collected emotional state data may be used in future comparisons for the participant.

The emotional state component 120 then determines the current emotional state of the participant by interpreting the received emotional state data in view of historical data collected from the participant (step 550). For example, if the emotional state component 120 determines that the participant sighed and then began typing with a high degree of pressure on the keyboard, the emotional state component 120 could determine that the participant is frustrated with the current communication. As another example, if the emotional state component 120 determines that the participant is talking in a friendly tone (e.g., if the monitoring component 140 detects that the participant is laughing) and is typing at a normal speed, the emotional state component 120 could determine that the participant is in a good mood during the presentation. Once the participant's emotional state is determined, the emotional state component 120 displays an indication of the determined emotional state to the presenter of the presentation (step 555), and the method 520 ends.

In one embodiment, an emotional state component 120 on the participant system determines the current emotional state of the participant (at step 550) and then transmits the determined current emotional state to a second emotional state component running on a presenter system. The second emotional state component then displays an indication of the determined emotional state to the presenter of the presentation (at step 555). As discussed above, the second emotional state component may be configured to display an indication of the collective emotional state of all the participants to the presentation. In such an embodiment, the collective emotional state may be based at least in part on the current emotional state for the participant determined at step 550. Advantageously, doing so enables any emotional state data collected by monitoring the actions of the participant to be maintained on the participant system, which may alleviate any privacy concerns of the participant. Additionally, by maintaining the historical data for the participant, the emotional state component 120 may account for participant-specific behaviors for the participant, which allows the emotional state component 120 to more accurately determine the participant's current emotional state.

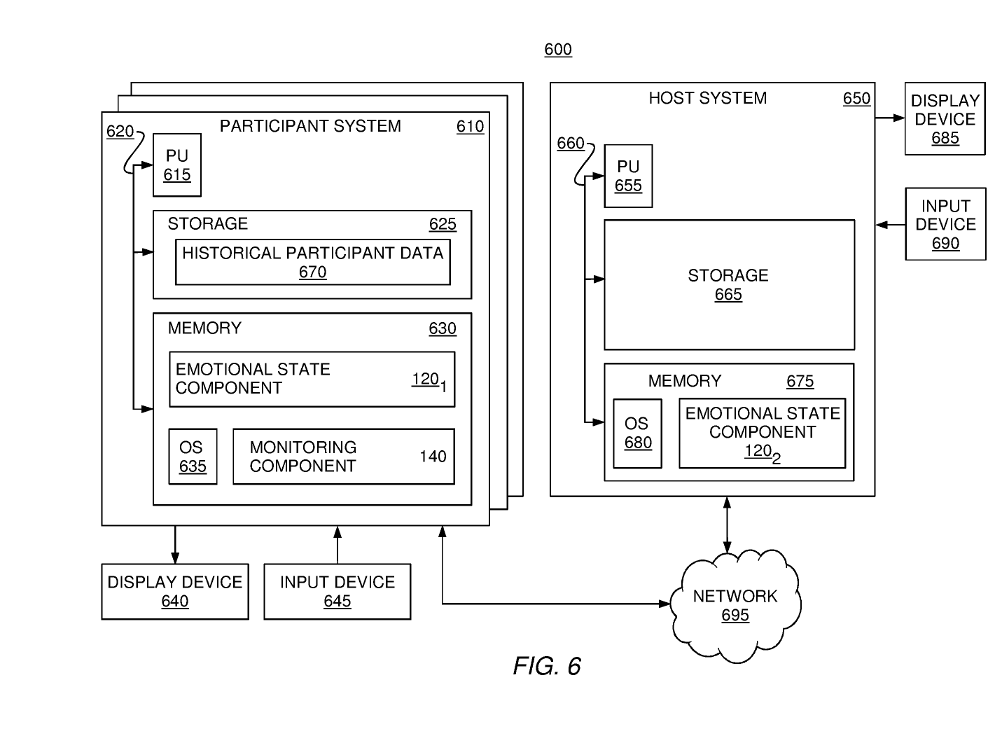

FIG. 6 is a block diagram illustrating a system configured to operate an emotional state component, according to one embodiment presented in this disclosure. As shown, the system 600 includes a plurality of participant systems 610 and a host system 650, communicatively coupled via a network 695. In one embodiment, the participant systems 610 may include existing computer systems, e.g., desktop computers, server computers, laptop computers, tablet computers, mobile devices (e.g., mobile phones), gaming consoles, hand-held gaming devices and the like. The participant systems 610 illustrated in FIG. 6, however, are merely examples of computer systems in which embodiments of the present invention may be used. Embodiments of the present invention may be implemented differently, regardless of whether the computer systems are complex multi-user computing systems, such as a cluster of individual computers connected by a high-speed network, single-user workstations or network appliances lacking non-volatile storage. Moreover, it is explicitly contemplated that embodiments of the invention may be implemented using any device or computer system capable of performing the functions described herein.

As shown, each participant system 610 includes, without limitation, a processor 615, which obtains instructions and data via a bus 620 from a memory 630 and storage 625. Processor 615 is a programmable logic device that performs instruction, logic and mathematical processing, and may be representative of one or more CPUs. Storage 625 is representative of hard-disk drives, flash memory devices, optical media and the like. Generally, the storage 625 stores application programs and data for use by the participant system 610. As shown, storage 625 contains historical participant data 670, which includes previously-monitor measurements and other data characterizing the participants to the communication. For example, the historical participant data 670 could contain previously-recorded typing speeds for a particular participant. The participant systems 610 are operably connected to the network 695, e.g., via network interfaces.

The memory 630 is any memory sufficiently large to hold the necessary programs and data structures. Memory 630 could be one or a combination of memory devices, including Random Access Memory, nonvolatile or backup memory (e.g., programmable or Flash memories, read-only memories, etc.). In addition, memory 630 and storage 625 may be considered to include memory physically located elsewhere; for example, on another computer coupled to the participant system 610 via bus 620. The memory 630 includes a monitoring component 140, an emotional state component 120₁ and an operating system (“OS”) 635. Operating system 635 is software used for managing the operation of the participant system 610. Examples of OS 635 include UNIX, versions of the Microsoft Windows® operating system and distributions of the Linux® operating system. (Note: Linux is a trademark of Linus Torvalds in the United States and other countries.) More generally, any operating system 635 capable of performing the functions described herein may be used.

Additionally, the participant systems 610 are each coupled to display devices 640 and input devices 645. The display devices 640 may include output devices such as monitors, touch screen displays, and so on. For instance, the display devices 640 may include a display device used to visually depict a presentation (e.g., a slideshow) being presented to the participant by a host of the communication. The input devices 645 represent a wide variety of input devices, including keyboards, mice, controllers, microphones, accelerometers and so on. Furthermore, the input devices 645 may include specialty hardware, such as keyboards configured to monitor a typing pressure of the participant.

As shown, the host system 650 includes, without limitation, a processor 655, which obtains instructions and data via a bus 660 from a memory 675 and storage 665. Processor 655 is a programmable logic device that performs instruction, logic and mathematical processing, and may be representative of one or more CPUs. Storage 665 is representative of hard-disk drives, flash memory devices, optical media and the like. Generally, the storage 665 stores application programs and data for use by the host system 650. The host system 650 is operably connected to the network 695, e.g., via a network interface.

The memory 675 is any memory sufficiently large to hold the necessary programs and data structures. Memory 675 could be one or a combination of memory devices, including Random Access Memory, nonvolatile or backup memory (e.g., programmable or Flash memories, read-only memories, etc.). In addition, memory 675 and storage 665 may be considered to include memory physically located elsewhere; for example, on another computer coupled to the host system 850 via bus 660. The memory 675 includes an emotional state component 120₂ and an operating system (“OS”) 680. Operating system 680 is software used for managing the operation of the host system 650. Examples of OS 680 include UNIX, versions of the Microsoft Windows® operating system and distributions of the Linux® operating system. More generally, any operating system 680 capable of performing the functions described herein may be used.

As discussed above, the monitoring component 140 generally monitors participants to the communication and provides emotional state data to an emotional state component (e.g., the emotional state component 120₁). For instance, the monitoring component 140 could monitor a participant's typing speed and application interaction during a particular teleconference and report this data to the emotional state component 120₁. The emotional state component 120₁ could compare this emotional state data with historical participant data 670 characterizing normal behavior of the participant to determine an emotional state of the participant. For instance, if the participant is typing at a much faster typing speed than normal, the emotional state component 120₁ could determine the participant is annoyed by something. Additionally, the emotional state component 120₁ may determine a topic of the teleconference and determine the emotional state of the participant further based on this topic. As an example, if the emotional state data indicates that the participant is using various applications that are unrelated to the topic of the teleconference, the emotional state component 120₁ may determine that the participant is uninterested in or bored with the teleconference. Upon determining the emotional state of the participant, the emotional state component 120₁ could transmit the determined emotional state to the emotional state component 120₂, which may display an indication of the determined emotional state to the host of the teleconference. Advantageously, doing so enables the host to determine how his presentation is affecting his audience and to make adjustments in his presentation style if necessary.

In the preceding, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the present invention, a user (e.g., a host to a communication having a plurality of participants) may access applications (e.g., an emotional state component 120) or related data available in the cloud. For example, the emotional state component 120 could execute on a computing system in the cloud and receive emotional state data from monitoring components 140 on participant systems. Here, the participant systems could be other computing systems within the cloud, standalone computing systems or a mix of both. Upon receiving the emotional state data, the emotional state component 120 could determine an emotional state of the participants and provide an indication of the determined emotional state to the host. In such a case, the emotional state component 120 could further determine the emotional state of the participants using historical emotional state data stored at a storage location in the cloud. Doing so allows users to identify the emotional state of their audience from a computing system attached to a network connected to the cloud (e.g., the Internet).

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations, can be implemented by special-purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method for indicating a collective emotional state of a plurality of participants to a communication, comprising:
receiving emotional state data for each of the plurality of participants to the communication, wherein the emotional state data was collected by monitoring one or more applications the respective participant is interacting with;
determining the collective emotional state of the plurality of participants to the communication, based on the received emotional state data and a determined topic of the communication; and
providing an indication of the collective emotional state of the plurality of participants to the communication.

2. The method of claim 1, wherein determining the collective emotional state for the plurality of participants to the communication further comprises determining, for each of the plurality of participants, whether the one or more applications the participant is interacting with are related to the determined topic of the communication.

3. The method of claim 1, wherein determining the collective emotional state of the plurality of participants to the communication is further based on historical emotional state data collected from at least one of the plurality of participants to the communication.

4. The method of claim 1, wherein determining the collective emotional state of the plurality of participants to the communication further comprises:
determining an individual emotional state for each of the plurality of participants to the communication,
wherein the collective emotional state of the plurality of participants is determined based on the individual emotional states.

5. The method of claim 4, further comprising:
providing an indication of at least one of the individual emotional states of the participants.

6. The method of claim 1, wherein the emotional state data was collected by further monitoring at least one of:
vibration levels of a computing device associated with the respective participant;
a typing speed of the respective participant on a keyboard connected to the computing device;
a typing pressure of the respective participant on the keyboard connected to the computing device; and
a pitch of one or more sounds uttered by the respective participant.

7. The method of claim 6, wherein the typing pressure is determined based on sound strength data captured using a microphone connected to the computing device, and wherein the sound strength data describes how loudly the respective participant was typing on the keyboard connected to the computing device.

8. The method of claim 1, wherein the emotional state data includes at least two monitored characteristics of the corresponding participant, and wherein determining a collective emotional state for the plurality of participants to the communication further comprises:
applying a respective weight to each of the monitored characteristics to determine the collective emotional state for the plurality of participants.

9. A computer program product for indicating a collective emotional state of a plurality of participants to a communication, comprising:
a computer-readable storage medium having computer readable program code embodied therewith, the computer readable program code comprising:
computer readable program code to receive emotional state data for each of the plurality of participants to the communication, wherein the emotional state data was collected by monitoring one or more applications the respective participant is interacting with;
computer readable program code to determine the collective emotional state of the plurality of participants to the communication, based on the received emotional state data and a determined topic of the communication; and
computer readable program code to provide an indication of the collective emotional state of the plurality of participants to the communication.

10. The computer program product of claim 9, wherein the computer readable program code to determine the collective emotional state for the plurality of participants to the communication further comprises computer readable program code to determine, for each of the plurality of participants, whether the one or more applications the participant is interacting with are related to the determined topic of the communication.

11. The computer program product of claim 9, wherein the computer readable program code to determine the collective emotional state of the plurality of participants to the communication is further based on historical emotional state data collected from at least one of the plurality of participants to the communication.

12. The computer program product of claim 9, wherein the computer readable program code to determine the collective emotional state of the plurality of participants to the communication further comprises:
computer readable program code to determine an individual emotional state for each of the plurality of participants to the communication,
wherein the collective emotional state of the plurality of participants is determined based on the individual emotional states.

13. The computer program product of claim 12, further comprising:
computer readable program code to provide an indication of at least one of the individual emotional states of the participants.

14. The computer program product of claim 9, wherein the emotional state data was collected using computer readable program code to monitor at least one of:
vibration levels of a computing device associated with the respective participant;
a typing speed of the respective participant on a keyboard connected to the computing device;
a typing pressure of the respective participant on the keyboard connected to the computing device; and
a pitch of one or more sounds uttered by the respective participant.

15. The computer program product of claim 14, wherein the typing pressure is determined based on sound strength data captured using computer readable program code to receive input from a microphone connected to the computing device, and wherein the sound strength data describes how loudly the respective participant was typing on the keyboard connected to the computing device.

16. The computer program product of claim 9, wherein the emotional state data includes at least two monitored characteristics of the corresponding participant, and wherein the computer readable program code to determine a collective emotional state for the plurality of participants to the communication further comprises:
computer readable program code to apply a respective weight to each of the monitored characteristics to determine the collective emotional state for the plurality of participants.

17. A system, comprising:
a processor; and
a memory containing a program that, when executed by the processor, performs an operation for indicating a collective emotional state of a plurality of participants to a communication, comprising:
receiving emotional state data for each of the plurality of participants to the communication, wherein the emotional state data was collected by monitoring one or more applications the respective participant is interacting with;
determining the collective emotional state of the plurality of participants to the communication, based on the received emotional state data and a determined topic of the communication; and
providing an indication of the collective emotional state of the plurality of participants to the communication.

18. The system of claim 17, wherein determining the collective emotional state for the plurality of participants to the communication further comprises determining, for each of the plurality of participants, whether the one or more applications the participant is interacting with are related to the determined topic of the communication.

19. The system of claim 17, wherein determining the collective emotional state of the plurality of participants to the communication is further based on historical emotional state data collected from at least one of the plurality of participants to the communication.

20. The system of claim 17, wherein determining the collective emotional state of the plurality of participants to the communication further comprises:
determining an individual emotional state for each of the plurality of participants to the communication,
wherein the collective emotional state of the plurality of participants is determined based on the individual emotional states.

21. The system of claim 19, the operation further comprising:
providing an indication of at least one of the individual emotional states of the participants.

22. The system of claim 17, wherein the emotional state data was collected by further monitoring at least one of:
vibration levels of a computing device associated with the respective participant;
a typing speed of the respective participant on a keyboard connected to the computing device;
a typing pressure of the respective participant on the keyboard connected to the computing device; and
a pitch of one or more sounds uttered by the respective participant.

23. The system of claim 22, wherein the typing pressure is determined based on sound strength data captured using a microphone connected to the computing device, and wherein the sound strength data describes how loudly the respective participant was typing on the keyboard connected to the computing device.

24. The system of claim 17, wherein the emotional state data includes at least two monitored characteristics of the corresponding participant, and wherein determining a collective emotional state for the plurality of participants to the communication further comprises:
applying a respective weight to each of the monitored characteristics to determine the collective emotional state for the plurality of participants.

25. A method for determining a collective emotional state of a plurality of participants to a communication, comprising:
monitoring one or more applications a participant is interacting with during a communication to collect emotional state data for the participant;
determining an emotional state of the participant, based on the collected emotional state data and a determined topic of the communication; and
transmitting the determined emotional state to a host system, whereby the collective emotional state of the plurality of participants is determined based on the transmitted emotional state of the participant and one or more emotional states collected from other participants in the plurality of participants.
